(19) United States
(12) Patent Application Publication
(10) Pub. No.: US 2020/0176738 A1
(43) Pub. Date: Jun. 4, 2020

(54) ENERGY STORAGE APPARATUS

(71) Applicant: GS Yuasa International Ltd., Kyoto-shi (JP)

(72) Inventors: Shogo TSURUTA, Kyoto-shi (JP); Akira WADA, Kyoto-shi, Kyoto (JP)

(21) Appl. No.: 16/621,177

(22) PCT Filed: Jun. 12, 2018
(86) PCT No.: PCT/JP2018/022300

§ 371 Date: Dec. 10, 2019

(30) Foreign Application Priority Data
Jun. 16, 2017 (JP) 2017-118223

(51) Int. Cl. H01M 2/10; H01M 2/30; H01M 2/20

(52) U.S. Cl. CPC H01M 2/1094; H01M 2/30; H01M 2/1061; H01M 2/206; H01M 2/1077; H01M 2/204

(57) ABSTRACT

An energy storage apparatus includes an energy storage device and an insulating member (holding member) including an opening corresponding to a terminal of the energy storage device. One of the insulating member and the terminal of the energy storage device includes a positioning portion abutting on a side surface of the other in the opening of the insulating member.

### TECHNICAL FIELD

The present invention relates to an energy storage apparatus including an energy storage device and an outer case that accommodates the energy storage device.

### BACKGROUND ART

Conventionally, an energy storage apparatus including an energy storage device and an outer case that accommodates the energy storage apparatus is known. The outer case includes an insulating member serving as an inner lid that holds the accommodated energy storage device (for example, see Patent Document 1). The insulating member includes an opening that exposes an electrode terminal of the energy storage device, and a connection member (bus bar) is connected to the electrode terminal through the opening.

### PRIOR ART DOCUMENT

### Patent Document

Patent Document 1: JP-A-2013-175442

### SUMMARY OF THE INVENTION

### Problems to be Solved by the Invention

The electrode terminal of the electrical storage device is relatively misaligned with an energy storage device body due to an individual difference. For this reason, the electrode terminal is misaligned even if the energy storage device is held by the insulating member. When a part of a connection member or an electrical component (for example, a circuit board, a temperature sensor, or a voltage sensor) is electrically connected to the misaligned electrode terminal, stable connection cannot be secured unless the part of the connection member or the electrical component is deformed, which results in a decrease in workability.

Thus, the present invention has been made in view of the above problems, and an object of the present invention is to provide an energy storage apparatus that can prevent the misalignment between the terminal of the energy storage device and the insulating member.

### Means for Solving the Problems

According to one aspect of the present invention, an energy storage apparatus includes: an energy storage device; and an insulating member including an opening corresponding to a terminal of the energy storage device. One of the insulating member and the terminal of the energy storage device includes a positioning portion abutting on a side surface of the other in the opening of the insulating member.

The positioning portion abutting on the side surface of the other in the opening of the insulating member is provided in one of the insulating member and the terminal, so that the relative misalignment between the insulating member and the terminal can be prevented by the positioning portion.

The energy storage apparatus may further include: a plurality of the energy storage devices arranged side by side in a first direction; and a connection member that electrically connects electrode terminals that are parts of the terminals of the plurality of energy storage devices. The positioning portion is a protrusion protruding toward at least one of the first direction and a second direction orthogonal to the first direction in the opening.

The positioning portion is a protrusion protruding toward at least one of the first direction and the second direction in the opening. When the positioning portion is the protrusion protruding toward the first direction, the protrusion can abut on the side surface of the other parallel to the second direction intersecting with the first direction in the opening. Consequently, the relative misalignment between the insulating member and the terminal in the first direction can be prevented. When the positioning portion is the protrusion protruding toward the second direction, the protrusion can abut on the side surface of the other parallel to the first direction in the opening. Consequently, the relative misalignment between the insulating member and the terminal in the second direction can be prevented. In this way, when the relative misalignment between the insulating member and the terminal is prevented, the necessity of deformation of the connection member is eliminated even if the connection member is connected to the electrode terminal, and the workability can be enhanced.

The energy storage apparatus may further include the plurality of energy storage devices arranged side by side in the first direction, each of the plurality of energy storage devices being a flat battery including an electrode assembly and a case in which the electrode assembly is accommodated. Each of the plurality of energy storage devices is disposed with a long side surface of the case facing the first direction and with a short side surface of the case facing the second direction orthogonal to the first direction, and the positioning portion is a protrusion abutting on the side surface of the other parallel to the second direction.

The positioning portion abuts on the side surface of the other parallel to the second direction, so that the relative misalignment between the insulating member and the terminal in the first direction can be prevented. In the energy storage device, the movement in the first direction that is the direction in which the energy storage device easily falls is restricted by the positioning portion, so that the energy storage device can be prevented from falling during or after the assembly.

The positioning portion may include an abutment portion abutting on the side surface of the other and an inclined portion that is inclined so as to be separated away from the side surface of the other as the inclined portion is away from the abutment portion.

Because the positioning portion includes the inclined portion that is inclined so as to be separated away from the other surface as the inclined portion is away from the abutment portion, the inclined portion guides the other member in assembling the insulating member and the energy storage device. Thus, the workability can be enhanced in assembling the insulating member and the energy storage device. Consequently, the positioning portion can smoothly perform the positioning.

According to another aspect of the present invention, a method for manufacturing an energy storage apparatus in which an insulating member including an opening corresponding to a terminal of an energy storage device is used, the method including the steps of; disposing the insulating member such that an inner surface of the insulating member faces upward; and causing the terminal to enter the opening of the insulating member while the terminal of the energy storage device faces downward, and causing a positioning portion provided in one of the insulating member and the terminal to abut on a side surface of the other.

The terminal of the energy storage device is caused to face downward with respect to the insulating member disposed with the inner surface facing upward, and enter the opening of the insulating member, and the positioning portion provided in one of the insulating member and the terminal abuts on the other. Thus, the relative misalignment between the insulating member and the terminal can be prevented. Consequently, the energy storage device can be disposed on the inner surface of the insulating member while the insulating member and the terminal are easily aligned.

### Advantages of the Invention

According to the energy storage apparatus of the present invention, the misalignment between the terminal of the energy storage device and the insulating member can be prevented.

### BRIEF DESCRIPTION OF THE DRAWINGS

FIG. 1 is a perspective view illustrating an appearance of an energy storage apparatus according to an embodiment.

FIG. 2 is an exploded perspective view illustrating each component when the energy storage apparatus of the embodiment is disassembled.

FIG. 3 is a perspective view illustrating a holding member of the embodiment when viewed from a positive side in a Z-axis direction.

FIG. 4 is a perspective view illustrating the holding member of the embodiment when viewed from a negative side in the Z-axis direction.

FIG. 5 is a perspective view illustrating a state in which the holding member of the embodiment holds a connection member when viewed from the positive side in the Z-axis direction.

FIG. 6 is a sectional view illustrating a surrounding structure of a connection member opening of the embodiment.

FIG. 7 is a sectional view illustrating the surrounding structure of the connection member opening of the embodiment.

FIG. 8 is a perspective view illustrating one step in positioning the holding member and the energy storage device of the embodiment.

FIG. 9 is a perspective view illustrating one step in positioning the holding member and the energy storage device of the embodiment.

FIG. 10 is a sectional view illustrating a surrounding structure of a connection member opening according to a modification.

### MODE FOR CARRYING OUT THE INVENTION

Hereinafter, an energy storage apparatus according to an embodiment and a modification of the present invention will be described with reference to the drawings. The following embodiment and modification described below illustrates a comprehensive or specific example. Numerical values, shapes, materials, components, dispositions of the components, connection forms of the components, and the like described in the following embodiment and modification are merely examples, and are not intended to limit the present invention. Among the components of the following embodiment and modification, the components that are not described in the independent claim indicating the highest concept are described as optional components. In each of the drawings, dimensions and the like are not strictly illustrated.

In the following description and drawings, an arrangement direction of electrode terminals in one energy storage device or a direction opposed to a short side surface of a case of the energy storage device is defined as an X-axis direction. An arrangement direction of energy storage devices, a direction opposed to a long side surface of the case of the energy storage device, or a thickness direction of the case is defined as a Y-axis direction. An arrangement direction of an outer case body and a lid of the energy storage apparatus, an arrangement direction of the energy storage device, a bus bar (connection member), and a substrate, an arrangement direction of a case body and the lid of the energy storage device, or a vertical direction is defined as a Z-axis direction. The X-axis direction, the Y-axis direction, and the Z-axis direction intersect with one another (hereinafter, orthogonal to one another in the embodiment). Although it may be conceivable that the Z-axis direction is not the vertical direction depending on a mode of use, hereinafter the Z-axis direction is described as the vertical direction for convenience of explanation. A positive side in the X-axis direction indicates an arrow direction side of the X axis, and a negative side in the X-axis direction indicates an opposite side to the positive side in the X-axis direction. The same applies to the Y-axis direction and the Z-axis direction.

### Embodiment

### [1. General Description of Energy Storage Apparatus 1]

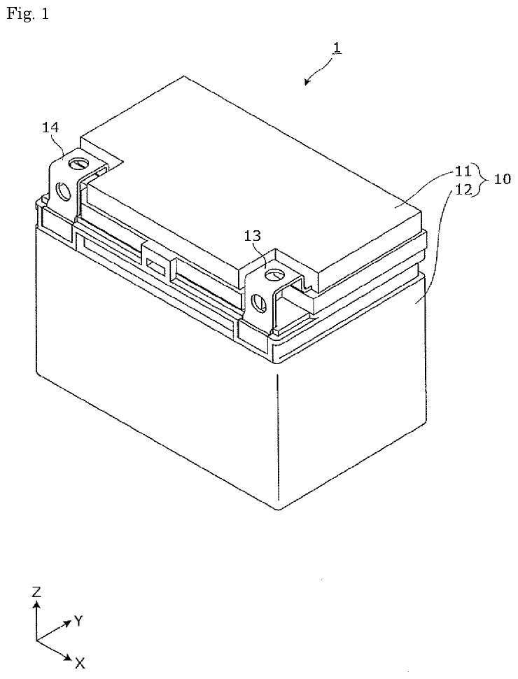

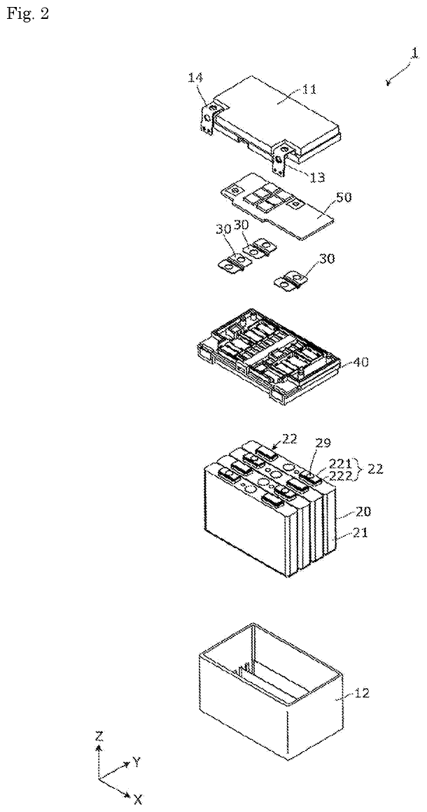

A general description of an energy storage apparatus 1 according to an embodiment will be given with reference to FIGS. 1 and 2. FIG. 1 is a perspective view illustrating an appearance of the energy storage apparatus 1 of the embodiment. FIG. 2 is an exploded perspective view illustrating each component when the energy storage apparatus 1 of the embodiment is disassembled.

The energy storage apparatus 1 is an apparatus that can charge electricity from an outside and discharge the electricity to the outside. The energy storage apparatus 1 is a battery module used for a power storage application, a power supply application, and the like. Specifically, for example, the energy storage apparatus 1 is used as a battery for driving or starting an engine of a moving body such as automobiles such as an electric vehicle (EV), a hybrid electric vehicle (HEV), and a plug-in hybrid electric vehicle (PHEV), motorcycles, watercrafts, snowmobiles, agricultural machines, and construction machines.

As illustrated in FIGS. 1 and 2, the energy storage apparatus 1 includes an outer case 10 including a lid 11 and an outer case body 12, a plurality of energy storage devices 20 accommodated in the outer case 10, a connection member 30, a holding member 40, and a substrate 50.

The outer case 10 is a rectangular (box-shaped) case (module case) constituting an outer case of the energy storage apparatus 1. That is, the outer case 10 is disposed outside the plurality of energy storage devices 20, the connection member 30, the holding member 40, the substrate 50, and the like, holds the energy storage devices 20 and the like at predetermined positions, and protects the energy storage devices 20 and the like from an impact and the like.

The outer case 10 includes the lid 11 constituting a lid of the outer case 10 and the outer case body 12 constituting a main body of the outer case 10. The lid 11 is a flat, rectangular member closing the opening of the outer case body 12, and includes an external terminal 13 on a positive electrode side and an external terminal 14 on a negative electrode side. The external terminals 13 and 14 are electrically connected to the energy storage device 20, and the energy storage apparatus 1 charges the electricity from the outside through the external terminals 13 and 14, and discharges the electricity to the outside through the external terminals 13 and 14. The outer case body 12 is a bottomed rectangular cylindrical housing (casing) in which an opening is formed, and accommodates the energy storage device 20 and the like.

For example, the external terminals 13 and 14 are made of a metal conductive member such as aluminum or an aluminum alloy. Other parts of the outer case 10 are made of an insulating material such as polycarbonate (PC), polypropylene (PP), polyethylene (PE), a polyphenylene sulfide resin (PPS), polybutylene terephthalate (PBT), and an ABS resin. This enables the outer case 10 to prevent the energy storage device 20 and the like from contacting with a metal member of the outside and the like.

The energy storage device 20 is a secondary battery (battery cell) that can charge and discharge the electricity, more specifically a nonaqueous electrolyte secondary battery such as a lithium ion secondary battery. The energy storage device 20 has a flat, rectangular parallelepiped (prismatic) shape. In the embodiment, four energy storage devices 20 are arranged in the Y-axis direction. A shape of the energy storage device 20 and the number of energy storage devices 20 to be arranged are not limited. The energy storage device 20 is not limited to the nonaqueous electrolyte secondary battery, but may be a secondary battery except for the nonaqueous electrolyte secondary battery, a capacitor, or a primary battery that can use stored electricity even if a user does not charge the battery.

Specifically, the energy storage device 20 includes a metal case 21, and a pair of terminals 22 (a positive electrode terminal and a negative electrode terminal 23) is provided in a lid portion of the case 21. The pair of terminals 22 is disposed so as to protrude from the lid portion of the case 21 toward the connection member 30 (upward, namely, toward the positive side of the Z-axis direction). The terminal 22 includes an electrode terminal 221 (a positive-electrode terminal and a negative-electrode terminal) to which the connection member 30 is connected and an insulating portion 222 insulating the electrode terminal 221 and the case 21 from each other. The electrode terminal 221 of the terminal 22 is connected to the external terminals 13, 14 through the connection member 30, which allows the energy storage apparatus 1 to charge and discharge the electricity from and to the outside. In the embodiment, each energy storage device 20 is disposed such that the positive electrode terminal and the negative electrode terminal of adjacent energy storage devices 20 are inverted.

A liquid injection portion that performs electrolyte solution filling, a gas release valve that discharges gas to release pressure during a pressure rise in the case 21, and the like may be provided in the lid portion of the case 21. An electrode assembly (also referred to as an energy storage element or a power generating element), a current collector (a positive electrode current collector and a negative electrode current collector), and the like are disposed in the case 21, and the electrolyte solution (nonaqueous electrolyte) or the like is enclosed in the case 21. However, detailed description is omitted.

The main body portion of the case 21 is formed in a flat box shape with an upper end opened. A side surface having the largest area in the main body portion of the case 21 is a long side surface, and a side surface having an area smaller than the long side surface is a short side surface. The long side surface of the main body portion of the case 21 faces the Y-axis direction, and the short side surface faces the X-axis direction.

The connection member 30 is a rectangular plate-shaped member that electrically connects the electrode terminals 221 of the plurality of energy storage devices 20 while being disposed on the holding member 40. The connection member 30 may be made of a metal conductive member such as copper, a copper alloy, aluminum, and an aluminum alloy.

In the embodiment, three connection members 30 are provided. The three connection members 30 are connection members connected to the electrode terminals 221 (the positive electrode terminals and the negative electrode terminals) of the four energy storage devices 20. Among the electrode terminals 221 of the four energy storage devices 20, the electrode terminal 221 to which the connection member 30 is not connected is connected to the external terminals 13, 14 through a bus bar (not illustrated). Thus, the external terminals 13, 14 and the four energy storage devices 20 are connected in series by the three connection members and the bus bar.

The holding member 40 is an electrical component tray that holds the substrate 50, the energy storage device 20, the connection member 30, and other wirings (not illustrated) while being disposed above the plurality of energy storage devices 20. The holding member 40 can insulate the substrate 50, the energy storage device 20, the connection member 30, and the like from other members, and regulate positions of the substrate 50, the connection member 30, and the like. The holding member 40 may be made of an insulating material such as PC, PP, PE, PPS, PBT, and ABS resins. Details of the holding member 40 will be described later.

The substrate 50 is a control substrate that is placed on and fixed to the holding member 40. Specifically, the substrate 50 includes a control circuit (not illustrated), acquires various pieces of information such as charge states and discharge states, voltage values, current values, and temperatures of the plurality of energy storage devices 20, controls on and off of a relay, and communicates with other devices.

### [2. Positional Relationship Among Holding Member, Terminal, and Connection Member]

Specific configurations of the respective members will be described below based on a positional relationship among the holding member 40, the terminal 22, and the connection member 30. A specific configuration of the holding member 40 will be described.

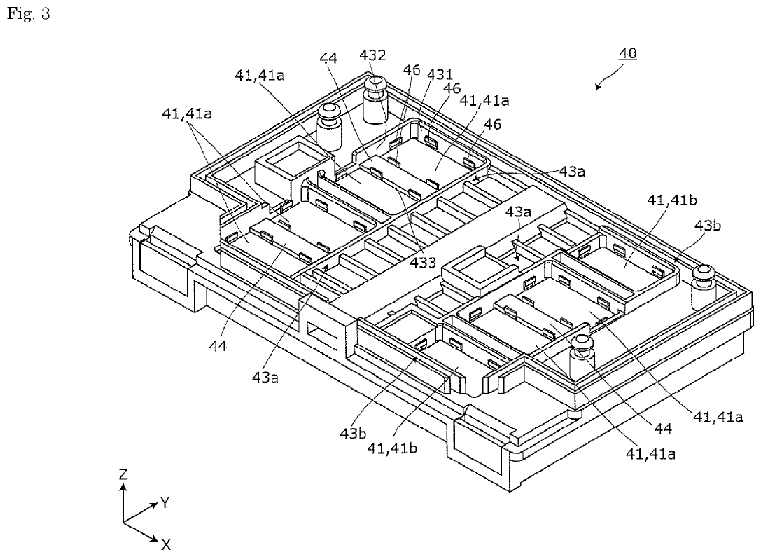

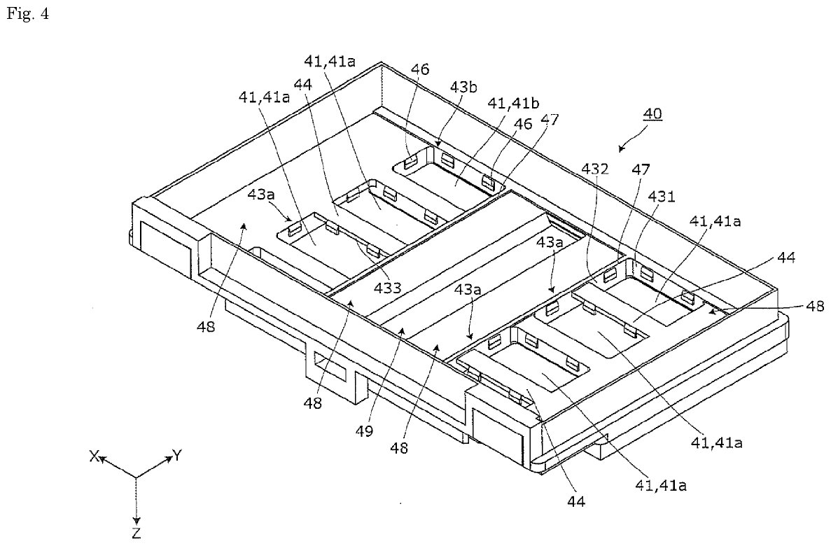

FIG. 3 is a perspective view illustrating the holding member 40 of the embodiment when viewed from the positive side in the Z-axis direction. FIG. 4 is a perspective view illustrating the holding member 40 of the embodiment when viewed from the negative side in the Z-axis direction.

As illustrated in FIGS. 3 and 4, in the holding member 40, an opening 41 that exposes the terminal 22 is formed at a position corresponding to the terminal 22 of each energy storage device 20. That is, the holding member 40 is an insulating member including the opening 41 corresponding to the terminal 22 of the energy storage device 20. Specifically, in the holding member 40, a total of eight openings 41 having a substantially rectangular shape in planar view are arranged in two rows and four columns. At this point, a row direction is the X-axis direction, and a column direction is the Y-axis direction. The pair of terminals 22 of one energy storage device 20 is disposed in the two openings 41 arranged in the same row. As illustrated in FIG. 4, a gas flow channel 49 through which an exhaust gas discharged from a gas release valve of the energy storage device 20 passes to the outside of the energy storage apparatus 1 is formed between the rows of the openings 41.

Note that, on a top face inside the holding member 40, a region that avoids the opening 41 and the gas flow channel 49 is formed in a substantial plane. This planar region is a bonding region 48 to which an adhesive bonding the energy storage device 20 to the holding member 40 is applied. On the top face inside the holding member 40, a pair of abutment walls 47 extending in the column direction protrudes from the plane of the bonding region 48 toward the Z-axis direction. In other words, the bonding region 48 is recessed by one stage from the abutment wall 47 on the top face inside the holding member 40. The pair of abutment walls 47 is disposed between each row of the openings 41 and the gas flow channel 49.

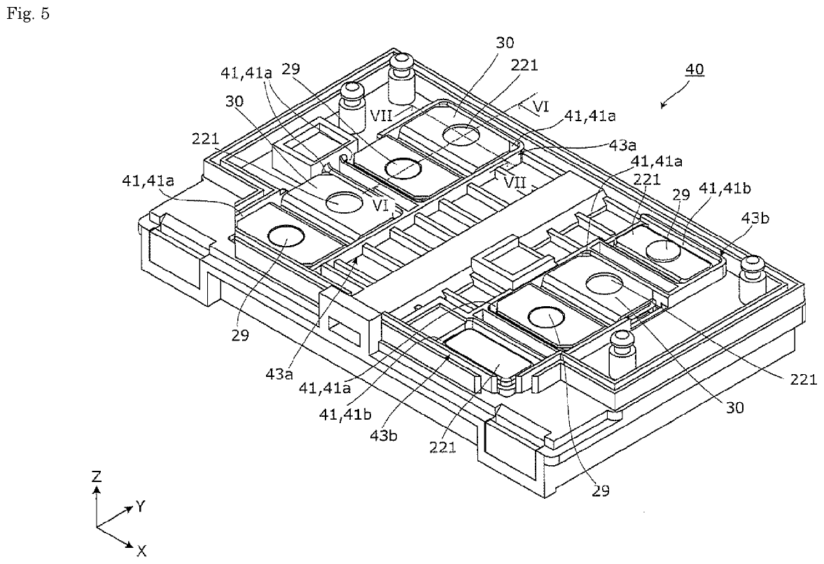

FIG. 5 is a perspective view illustrating a state in which the holding member 40 of the embodiment holds the connection member 30 when viewed from the positive side in the Z-axis direction. As illustrated in FIG. 5, each of the eight openings 41 includes a connection member opening 41a in which the connection member 30 is disposed and a bus bar opening 41b in which the bus bar (not illustrated) is disposed. Two connecting member openings 41a adjacent to each other in the Y-axis direction are paired, and one connecting member 30 is disposed with respect to one pair of connection member openings 41a. In the row on the negative side in the X-axis direction, all four openings 41 are connection member openings 41a. Two pairs of connection member openings 41a are provided in the row on the negative side in the X-axis direction. On the other hand, in the row on the positive side in the X-axis direction, the openings 41 at both ends are bus bar openings 41b, and the remaining openings 41 are connection member openings 41a. The pair of connection member openings 41a is provided in the row on the positive side in the X-axis direction. Each pair of connection member openings 41a is surrounded by a surrounding wall 43a. Each bus bar opening 41b is surrounded by a surrounding wall 43b. In the surrounding wall 43a, a long beam 44 is stretched in the X-axis direction. Two spaces surrounded by the surrounding wall 43a and the beam 44 constitute the pair of connection member openings 41a.

As described above, a plurality of positioning portions 46 that directly abut on the terminal 22 to position the terminal 22 are provided in the surrounding wall 43a and the beam 44 constituting the connection member opening 41a and the surrounding wall 43b constituting the bus bar opening 41b.

The positioning portion 46 will be described in detail. The positioning portion 46 in the pair of connection member openings 41a will be described, and the description of the positioning portion 46 in the bus bar opening 41b will be omitted.

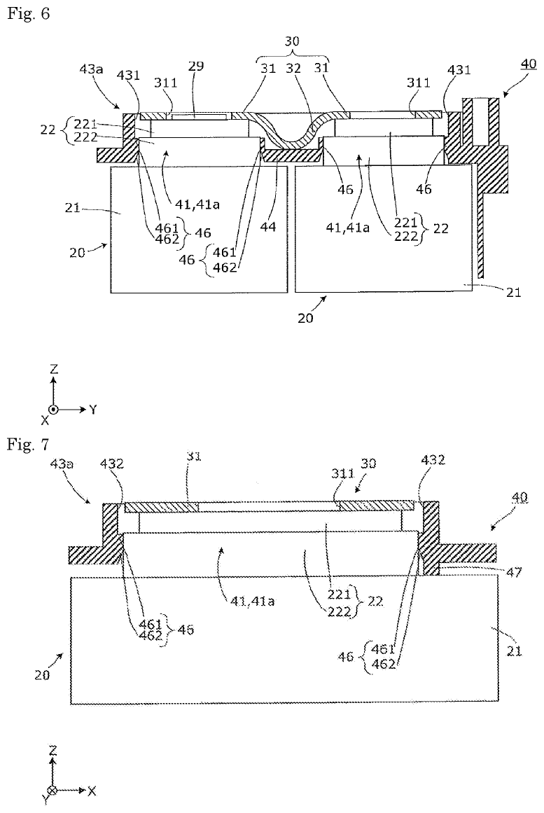

FIGS. 6 and 7 are sectional views illustrating a surrounding structure of the connection member opening 41a of the embodiment. Specifically, FIG. 6 is a sectional view illustrating a cut surface parallel to a YZ-plane including a line VI-VI in FIG. 5. FIG. 7 is a sectional view illustrating a cut surface parallel to a ZX-plane including a line VII-VII in FIG. 5. In FIGS. 6 and 7, the energy storage device 20 is not illustrated in sectional view, but an outer shape of the energy storage device 20 is illustrated.

As illustrated in FIGS. 5 to 7, in the surrounding wall 43a, an inner wall surface extending in the X-axis direction is set to a first wall surface 431, and an inner wall surface extending in the Y-axis direction is set to a second wall surface 432. In the beam 44, an inner wall surface extending in the X-axis direction is set to a third wall surface 433.

In one connection member opening 41a, two positioning portions 46 are arranged on the first wall surface 431 at a predetermined interval in the X-axis direction. The positioning portion 46 of the first wall surface 431 is a protrusion protruding in the Y-axis direction (first direction) so as to go to the inside of the connection member opening 41a. In one connection member opening 41a, one positioning portion 46 is provided on each of the pair of opposing second wall surfaces 432. The positioning portion 46 of the second wall surface 432 is a protrusion protruding in the X-axis direction (second direction) so as to go to the inside of the connection member opening 41a. In one connection member opening 41a, two positioning portions 46 are arranged on the third wall surface 433 at a predetermined interval in the X-axis direction. The positioning portion 46 of the third wall surface 433 is a protrusion protruding in the Y-axis direction so as to go to the inside of the connection member opening 41a in a state of extending upward from the beam 44.

The positioning portion 46 includes an abutment portion 461 that directly abuts on the side surface of the terminal 22 and an inclined portion 462 continuous with the abutment portion 461. The inclined portion 462 is inclined so as to be separated away from the side surface of the terminal 22 as the inclined portion 462 is away from the abutment portion 461. That is, the inclined portion 462 is inclined so as to go to the inside of the connection member opening 41a as it goes in the direction in which the terminal 22 enters the connection member opening 41a (the positive side in the Z-axis direction). Because the inclined portion 462 is inclined in this way, the terminal 22 can be guided by the inclined portion 462 when the terminal 22 enters the connection member opening 41a.

A specific configuration of the connection member 30 will be described below.

As illustrated in FIGS. 6 and 7, the connection member 30 integrally includes a pair of opposing portions 31 opposed to the electrode terminal 221 and a bent portion 32 bend onto the side of the energy storage device 20 from the pair of opposing portions 31. A circular through-hole 311 is made in the opposing portion 31, and the opposing portion 31 and the electrode terminal 221 are welded through the through-hole 311. The bent portion 32 is disposed between the pair of opposing portions 31, and formed in a substantial cosine-wave shape. Thus, the bent portion 32 is disposed between the terminals 22 of the pair of adjacent energy storage devices 20. Because the bent portion 32 is provided in the connection member 30, stress during thermal expansion can be absorbed by the bent portion 32 even if the connection member 30 thermally expands.

A specific configuration of the terminal 22 will be described below.

As illustrated in FIGS. 6 and 7, the terminal 22 of the energy storage device 20 is disposed on the surface of the lid portion of the case 21. The surface of the lid portion of the case 21 is a terminal arrangement surface 223 on which the terminal 22 is disposed. The surrounding walls 43a, 43b and the beam 44 of the holding member 40 are disposed above the terminal arrangement surface 223. The bent portion 32 of the connection member 30 is disposed above the beam 44. In this way, the bent portion 32 of the connection member 30 and the beam 44 are disposed so as to overlap the terminal arrangement surface 223 of the energy storage device 20, so that the bent portion 32 of the connection member 30 and the beam 44 are not disposed between the cases 21 of the two energy storage devices 20. Thus, an interval between the two energy storage devices 20 can be narrowed.

As described above, the terminal 22 includes the insulating portion 222 and the electrode terminal 221 protruding upward from the insulating portion 222. The electrode terminal 221 is a square-shaped terminal having a substantially rectangular shape in planar view (see FIG. 2 and the like). The electrode terminals 221 on the positive electrode side and the negative electrode side are made of metal such as aluminum or an aluminum alloy as a whole. A circular portion 29 protrudes from the upper surface of the electrode terminal 221 on the negative electrode side. The circular portion 29 is made of copper or a copper alloy.

The insulating portion 222 is formed in a substantially rectangular shape in planar view using an insulating material such as PC, PP, PE, PPS, PBT, or ABS resin. The abutment portion 461 of the positioning portion 46 abuts on the outside surface of the insulating portion 222. Specifically, when viewed from the YZ-plane as illustrated in FIG. 6, the abutment portion 461 of the positioning portion 46 of the first wall surface 431 directly abuts on the insulating portion 222 from the Y-axis direction in the connection member opening 41a. In the connection member opening 41a, the abutment portion 461 of the positioning portion 46 of the third wall surface 433 directly abuts on the insulating portion 222 from the Y-axis direction. In this way, the insulating portion 222 is sandwiched between the positioning portion 46 of the first wall surface 431 and the positioning portion 46 of the third wall surface 433.

On the other hand, when viewing the ZX-plane as illustrated in FIG. 7, in the connection member opening 41a, the abutment portion 461 of the positioning portion 46 of one of the second wall surfaces 432 directly abuts on the insulating portion 222 from the X-axis direction. In the connection member opening 41a, the abutment portion 461 of the positioning portion 46 of the other second wall surface 432 directly abuts on the insulating portion 222 from the X-axis direction. As described above, the insulating portion 222 is sandwiched between the positioning portions 46 of the pair of second wall surfaces 432. Thus, the insulating portion 222 is positioned in the X-axis direction and the Y-axis direction by the plurality of positioning portions 46.

### [3. Positioning Procedure]

The positioning of the holding member 40 and the energy storage device 20 will be described below.

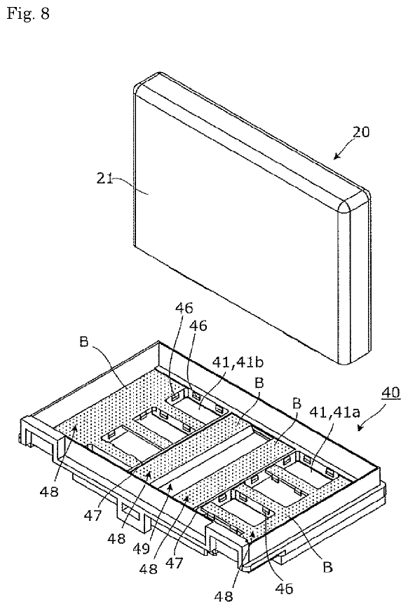

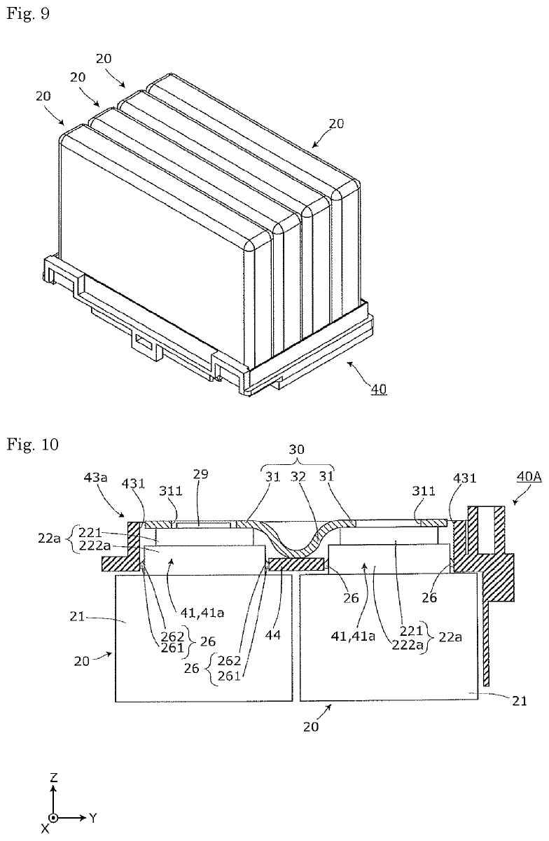

FIGS. 8 and 9 are perspective views illustrating one step in positioning the holding member 40 and the energy storage device 20 of the embodiment.

As illustrated in FIG. 8, an operator places the holding member 40 upside down such that the top face inside the holding member 40 faces upward. Subsequently, the operator applies an adhesive B to the bonding region 48 of the holding member 40. In FIG. 8, the adhesive B is indicated by shading. As illustrated in FIG. 8, on the top face inside of the holding member 40, the adhesive B is applied to a place avoiding the abutment wall 47 and the gas flow channel 49. That is, the adhesive B is also applied between the gas flow channel 49 and the abutment wall 47.

Subsequently, the operator assembles the energy storage device 20 to the holding member 40. Specifically, the operator adjusts a posture of the energy storage device 20 such that the pair of terminals 22 faces downward, and then causes the pair of terminals 22 to enter the pair of openings 41 arranged in the row direction. When entering the pair of openings 41, the terminal 22 is guided to a predetermined position by the inclined portion 462 of the positioning portion 46. Subsequently, the lid portion of the case 21 of the energy storage device 20 abuts on the pair of abutment walls 47, whereby further entry of the terminal 22 is restricted. As described above, on the top face inside the holding member 40, the bonding region 48 is recessed by one stage from the abutment wall 47 in the Z-axis direction. The adhesive B is disposed in the recess, and the adhesive can be held with an appropriate thickness between the lid portion of case 21 of the energy storage device 20 and the top face inside the holding member 40.

At this point, because the abutment portions 461 of the plurality of positioning portions 46 directly abut on the terminal 22 in the X-axis direction and the Y-axis direction, the energy storage device 20 is positioned at a predetermined position. In particular, although the energy storage device 20 of the embodiment easily falls in the Y-axis direction, the movement of the energy storage device 20 in the Y-axis direction is restricted by the positioning portion 46, so that the energy storage device 20 can be prevented from falling even in or after the assembly before the adhesive B is hardened.

By attaching the remaining energy storage devices 20 to the holding member 40, the four energy storage devices 20 are bonded to the holding member 40 while being positioned with respect to the holding member 40 as illustrated in FIG. 9. When the adhesive B is hardened, the operator re-arranges the integrated holding member 40 and four energy storage devices 20 in a normal posture (a posture in which the holding member 40 faces upward). In this state, the operator welds the connection member 30 to the electrode terminal 221 of each energy storage device 20 exposed from the opening 41 of the holding member 40. At this point, the connection member 30 and the electrode terminal 221 are welded through the through-hole 311 of the connection member 30. In the electrode terminal 221 on the negative electrode side in the energy storage device 20, the circular portion 29 is disposed in the through-hole 311 of the connection member 30. For this reason, on the negative electrode side, the connection member 30 and the electrode terminal 221 are welded at a portion avoiding the circular portion 29.

In this way, during the welding, because the electrode terminal 221 of each energy storage device 20 is disposed at a predetermined position by the positioning portion 46, the connection member 30 and the electrode terminal 221 can be positioned without deforming the connection member 30, and good workability is obtained.

In the embodiment, by way of example, the energy storage device 20 is assembled to the inverted holding member 40. Alternatively, the energy storage device 20 may be assembled to the holding member 40 that is not inverted. That is, the energy storage device 20 may be assembled so as to be inserted from below the holding member 40 in the normal posture.

### [4. Description of Effects]

As described above, according to the embodiment, the energy storage apparatus 1 includes the energy storage device 20 and the holding member 40 (insulating member) including the opening 41 corresponding to the terminal 22 of the energy storage device 20. One of the holding member 40 and the terminal 22 of the energy storage device 20 includes the positioning portion 46 that abuts on the side surface of the other in the opening 41 of the holding member 40.

The positioning portion 46 that abuts on the side surface of one of the holding member 40 and the terminal 22 in the opening 41 of the holding member 40 is provided in the other, so that the relative misalignment between the holding member 40 and the terminal 22 can be prevented by the positioning portion 46.

The energy storage apparatus 1 further includes the plurality of energy storage devices 20 arranged side by side in the first direction (Y-axis direction) and the connection member 30 that electrically connects the electrode terminals 221 that are parts of the terminals 22 of the plurality of energy storage devices 20. The positioning portion 46 is a protrusion protruding toward at least one of the first direction and the second direction (X-axis direction) orthogonal to the first direction in the opening 41.

The positioning portion 46 is a protrusion protruding toward at least one of the first direction and the second direction in the opening 41. When the positioning portion 46 is the protrusion protruding toward the first direction, the protrusion can abut on the side surface of the other parallel to the second direction intersecting with the first direction in the opening 41. Consequently, the relative misalignment between the holding member 40 and the terminal 22 in the first direction can be prevented. When the positioning portion 46 is the protrusion protruding toward the second direction, the protrusion can abut on the side surface of the other parallel to the first direction in the opening 41. Consequently, the relative misalignment between the holding member 40 and the terminal 22 in the second direction can be prevented. In this way, when the relative misalignment between the holding member 40 and the terminal 22 is prevented, necessity of the deformation of the connection member 30 is eliminated even if the connection member 30 is connected to the electrode terminal 221 through the holding member 40, and the workability can be enhanced.

In particular, when the energy storage apparatus 1 is a motorcycle battery, an overall size is smaller than that of an automobile battery. For this reason, as compared with the automobile battery, the place where the electrode terminal 221 is welded to the connection member 30 has also a small area, and therefore strength of the welding is decreased. Even if the welding strength is decreased in this way, the deformation of the connection member 30 is prevented, so that the stable welding can be maintained.

The energy storage device 20 is a flat battery including the electrode assembly and the case 21 in which the electrode assembly is accommodated. The energy storage apparatus 1 includes the plurality of energy storage devices 20 arranged side by side in the first direction. Each of the plurality of energy storage devices 20 is disposed with the long side surface of the case 21 facing the first direction and with the short side surface of the case 21 facing the second direction orthogonal to the first direction. The positioning portion 46 is a protrusion abutting on the side surface of the other parallel to the second direction.

The positioning portion 46 abuts on the side surface of the other parallel to the second direction, so that the relative misalignment between the holding member 40 and the terminal 22 in the first direction can be prevented. In the energy storage device 20, the movement in the first direction that is the direction in which the energy storage device 20 easily falls is restricted by the positioning portion 46, so that the energy storage device 20 can be prevented from falling during or after the assembly. The positioning by the positioning portion 46 is continued even after the assembly, the inclination of the energy storage device 20 due to a vibration or the like can be prevented even if the bonding of the adhesive B is insufficient.

The positioning portion 46 includes the abutment portion 461 abutting on the side surface of the other and the inclined portion 462 that is inclined so as to be separated away from the side surface of the other as the inclined portion 462 is away from the abutment portion 461.

Because the positioning portion 46 includes the inclined portion 462 that is inclined so as to be separated away from the other surface as the inclined portion 462 is away from the abutment portion 461, the inclined portion 462 guides the other member (in the embodiment, the terminal 22) in assembling the holding member 40 and the energy storage device 20. Thus, the workability can be enhanced in assembling the holding member 40 and the energy storage device 20. Consequently, the positioning portion 46 can smoothly perform the positioning.

A method for manufacturing the energy storage apparatus 1 of the embodiment is a method for manufacturing the energy storage apparatus 1 using the holding member 40 (insulating member) including the opening 41 corresponding to the terminal 22 of the energy storage device 20, and the method for manufacturing the energy storage apparatus 1 includes a step of disposing the holding member 40 such that the inner surface of the holding member 40 faces upward and a step of causing the terminal 22 to enter the opening 41 of the holding member 40 while the terminal 22 of the energy storage device 20 faces downward, and of causing the positioning portion 46 provided in one of the holding member 40 and the terminal 22 to abut on the side surface of the other.

The terminal 22 of the energy storage device 20 is caused to enter the opening 41 of the holding member 40 is caused to enter the holding member 40 disposed with the inner surface facing upward the holding member 40 disposed with the inner surface facing upward while the terminal 22 of the energy storage device 20 faces downward, and the positioning portion 46 provided in one of the holding member 40 and the terminal 22 abuts on the other, so that the relative misalignment between the holding member 40 and the terminal 22 can be prevented. Consequently, the energy storage device 20 can be disposed on the inner surface of the holding member 40 while the holding member 40 and the terminal 22 are easily aligned.

### (Modification)

In the above embodiment, by way of example, the positioning portion 46 is provided in the holding member 40. However, in a modification, the positioning portion provided in the terminal of the energy storage device will be described. In the following description, the same component as the above embodiment is denoted by the same reference numeral, and sometimes the description is omitted.

FIG. 10 is a sectional view illustrating the surrounding structure of the connection member opening 41a of the modification. FIG. 10 is a view corresponding to FIG. 6. As illustrated in FIG. 10, the positioning portion is not provided in the connection member opening 41a of a holding member 40A. On the other hand, a positioning portion 26 abutting on the holding member 40A is provided in a terminal 22a of the energy storage device 20. Specifically, the positioning portion 26 is a protrusion provided on an outer peripheral surface of an insulating portion 222a of the terminal 22a, and the positioning portion 26 protrudes in the Y-axis direction toward the holding member 40A. The positioning portion 26 includes an abutment portion 261 abutting on the wall surface constituting the connection member opening 41a of the holding member 40A and an inclined portion 262 continuous with the abutment portion 261. The inclined portion 262 is inclined so as to be separated away from the wall surface constituting the connection member opening 41a as the inclined portion 262 is away from the abutment portion 261. That is, the inclined portion 262 is inclined so as to go to the inside of the connection member opening 41a as it goes in the direction in which the terminal 22a enters the connection member opening 41a (the positive side in the Z-axis direction). Because the inclined portion 262 is inclined in this way, the terminal 22a can be guided by the inclined portion 262 when the terminal 22a enters the connection member opening 41a.

The positioning portion can also be provided in each of the holding member and the terminal.

### [Others]

Although the energy storage apparatus of the embodiment of the present invention is described above, the present invention is not limited to the above embodiment and modification. That is, it should be understood that the embodiment and modification disclosed this time are illustrative in all points and not restrictive. The scope of the present invention is illustrated by not the above description, but the scope of the claims, and is intended to include all changes within the scope of the claims and meaning equivalent to the scope of the claims.

In the above embodiment, by way of example, the connection member 30 connects the electrode terminals 221 of the two energy storage devices 20. Alternatively, the electrode terminals of at least three energy storage devices may be connected by one connection member.

In the above embodiment, by way of example, the positioning portion 46 is the protrusion. Alternatively, the positioning portion may have any shape as long as the positioning portion abuts on the positioning target. An inclined portion in which the entire circumference of the wall surface constituting the opening 41 is continuous or intermittently tapered may be used as the positioning portion.

In the above embodiment, by way of example, the connection member 30 and the electrode terminal 221 are joined by the welding. Alternatively, the connection member 30 and the electrode terminal 221 may be joined by another joining method. Another joining method includes fastening such as screwing.

In the above embodiment, by way of example, the electrode terminal 221 has the substantially rectangular shape in planar view. Alternatively, the electrode terminal may have any shape. Other shapes of the electrode terminals include a columnar shape.

In the electrode assembly accommodated in the case 21 of the energy storage device 20, an insulating separator is disposed between the belt-shaped positive electrode plate and negative electrode plate, so that a positive electrode plate and a negative electrode plate are electrically insulated. The electrode assembly may be a winding type in which the separator is disposed on the negative electrode plate, the positive electrode plate is disposed on the separator, and the separator is further disposed on the positive electrode plate to form a cylindrical shape. The winding type may be what is called a “vertical winding system” in which a winding axis is accommodated in the case 21 in a posture along the longitudinal direction (X-direction) of the case 21 or what is a called a “horizontal winding system” in which the winding axis is accommodated in the case 21 in a posture along a height direction (Z-direction) of the case 21. The electrode assembly is not limited to the winding type, but may be a laminated type in which pluralities of positive electrode plates, negative electrode plates, and separators formed in a substantially square sheet shape are laminated in the short direction (Y-direction) of the case 21. The outer case that accommodates the electrode assembly is not limited to the metal rectangular case made of aluminum or stainless steel illustrated in the above embodiment, but may be a pouch type in which the electrode assembly is packaged with a film-shaped material.

The terminal 22 of the energy storage device 20 has the flat plate shape disposed on the lid portion in the posture parallel to the lid portion of the case 21. Alternatively, the terminal 22 may have a tab shape protruding outward from the inside of the case at the end of the case of the energy storage device. The tab-shaped terminal can particularly be adopted in the above pouch-type case. In the tab-shaped terminal, the adjacent energy storage devices 20 are electrically connected to each other by directly fixing the tab-shaped terminals of the adjacent energy storage devices 20 by a welding method with no use of the connection member 30 described in the above embodiment. As described above, the case where the electrically connected adjacent terminals are disposed in the opening of the insulating member is also within the scope of the present invention. Even in the energy storage device including the connected tab-shaped terminal, it is necessary to prevent the misalignment with the insulating member, and the positioning portion of the present invention can be adopted. Specifically, the positioning portion can be disposed so as to directly abut on the wide surface from the direction perpendicular to the wide surface of the tab-shaped terminal, or the positioning portion can be disposed so as to directly abut on the end (edge) of the terminal from the direction parallel to the wide surface of the tab-shaped terminal. The misalignment between the terminal and the insulating member can be prevented, so that the workability of the positioning portion of the present invention can be improved when the circuit board, the temperature sensor, or the voltage sensor is electrically connected to the terminal.

A form constructed by any combination of the embodiment and the modification is also included in the scope of the present invention.

### INDUSTRIAL APPLICABILITY

The present invention can be applied to the energy storage apparatus including the energy storage device such as a lithium ion secondary battery.

### DESCRIPTION OF REFERENCE SIGNS

1: energy storage apparatus

10: outer case

11: lid

12: outer case body

13, 14: external terminal

20: energy storage device

21: case

22, 22a: terminal

26, 46: positioning portion

29: circular portion

30: connection member

31: opposing portion

32: bent portion

40, 40A: holding member (insulating member)

41: opening

41a: connection member opening

41b: bus bar opening

43a, 43b: surrounding wall

44: beam

47: abutment wall

48: bonding region

49: gas flow channel

50: substrate

221: electrode terminal

222, 222a: insulating portion

223: terminal arrangement surface

261, 461: abutment portion

262, 462: inclined portion

311: through-hole

431: first wall surface

432: second wall surface

433: third wall surface

B: adhesive

1. An energy storage apparatus comprising:
an energy storage device; and
an insulating member including an opening corresponding to a terminal of the energy storage device,
wherein one of the insulating member and the terminal of the energy storage device includes a positioning portion abutting on a side surface of another in the opening of the insulating member.

2. The energy storage apparatus according to claim 1, further comprising:
a plurality of the energy storage devices arranged side by side in a first direction; and
a connection member that electrically connects electrode terminals that are parts of the terminals of the plurality of energy storage devices,
wherein the positioning portion is a protrusion protruding toward at least one of the first direction and a second direction orthogonal to the first direction in the opening.

3. The energy storage apparatus according to claim 1, further comprising a plurality of the energy storage devices arranged side by side in a first direction, each of the plurality of energy storage devices being a flat battery including an electrode assembly and a case in which the electrode assembly is accommodated,
wherein each of the plurality of energy storage devices is disposed with a long side surface of the case facing the first direction and with a short side surface of the case facing a second direction orthogonal to the first direction, and
the positioning portion is a protrusion abutting on the side surface of the other parallel to the second direction.

4. The energy storage apparatus according to claim 1, wherein the positioning portion includes an abutment portion abutting on the side surface of the other and an inclined portion that is inclined so as to be separated away from the side surface of the other as the inclined portion is away from the abutment portion.

5. A method for manufacturing an energy storage apparatus in which an insulating member including an opening corresponding to a terminal of an energy storage device is used, the method comprising:
disposing the insulating member such that an inner surface of the insulating member faces upward; and
causing the terminal to enter the opening of the insulating member while the terminal of the energy storage device faces downward, and causing a positioning portion provided in one of the insulating member and the terminal to abut on a side surface of another.
